(19) United States
(12) Patent Application Publication
(10) Pub. No.: US 2010/0146236 A1
(43) Pub. Date: Jun. 10, 2010

(54) SYSTEM, METHOD, AND COMPUTER PROGRAM PRODUCT FOR RENDERING AT LEAST A PORTION OF DATA USELESS IN IMMEDIATE RESPONSE TO A DELETE COMMAND

(76) Inventor: Radoslav Danilak, Cupertino, CA (US)

Correspondence Address: Zilka-Kotab, PC, P.O. BOX 721120, SAN JOSE, CA, 95172-1120, US

(21) Appl. No.: 12/330,183

(22) Filed: Dec. 8, 2008

(51) Int. Cl. G06F 12/02

(52) U.S. Cl. 711/166; 711/E12.002

(57) ABSTRACT

A system, method, and computer program product are provided for rendering at least a portion of data useless in immediate response to a delete command. In operation, a delete command directed to an operating system is received for deleting data from memory. Furthermore, in immediate response to the delete command, a process is initiated for rendering at least a portion of the data useless.

### FIELD OF THE INVENTION

The present invention relates to computer systems, and more particularly to rendering data in storage systems of such computer systems useless.

### BACKGROUND

In current computer architectures, operating systems typically only mark data to be deleted from a storage system, leaving the data on the storage system of a computer. This creates a security risk, as multiple users of the same system may be able to access this data. Furthermore, in some cases, it may be desirable to write over the data to be deleted. Writing over such data utilizes system resources and thus causes performance degradation of such system. There is thus a need for addressing these and/or other issues associated with the prior art.

### SUMMARY

A system, method, and computer program product are provided for rendering at least a portion of data useless in immediate response to a delete command. In operation, a delete command directed to an operating system is received for deleting data from memory. Furthermore, in immediate response to the delete command, a process is initiated for rendering at least a portion of the data useless.

### BRIEF DESCRIPTION OF THE DRAWINGS

FIG. 1 shows a method for rendering at least a portion of data useless in immediate response to a delete command, in accordance with one embodiment.

FIG. 2 shows a system for rendering at least a portion of data useless in immediate response to a delete command, in accordance with one embodiment.

FIG. 3A shows a method for rendering at least a portion of data useless in immediate response to a delete command, in accordance with another embodiment.

FIG. 3B shows a method for rendering at least a portion of data useless in immediate response to a delete command, in accordance with another embodiment.

FIG. 3C shows a method for rendering at least a portion of data useless in immediate response to a delete command, in accordance with another embodiment.

FIG. 4 illustrates an exemplary system in which the various architecture and/or functionality of the various previous embodiments may be implemented.

### DETAILED DESCRIPTION

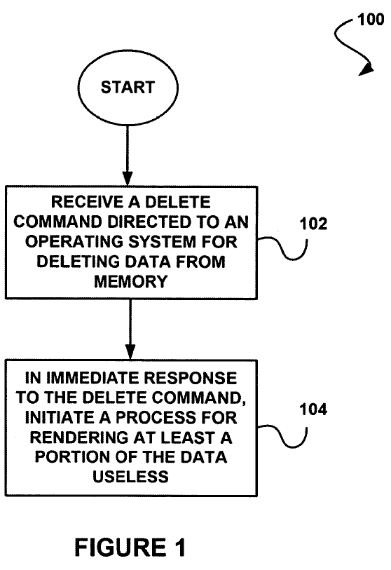

FIG. 1 shows a method 100 for rendering at least a portion of data useless in immediate response to a delete command, in accordance with one embodiment. As shown, a delete command directed to an operating system is received for deleting data from memory. See operation 102.

Furthermore, in immediate response to the delete command, a process is initiated for rendering at least a portion of the data useless. See operation 104. The process for rendering at least a portion of the data useless may include a variety of processes.

For example, in one embodiment, the process may include a background process. In another embodiment, the data may be encrypted and the process may include deleting a key associated with the encryption. In yet another embodiment, the process may include zeroing at least the portion of the data.

In some cases, the process may result in an appearance that the at least a portion of the data is zeroed. In another embodiment, the process may result in the memory being used as scratch memory. It should be noted that the data may be rendered useless in any manner such that the data is deemed useless. For example, the data may be rendered useless by deleting at least a portion of the data, zeroing at least a portion of the data, writing over at least a portion of the data, prohibiting access to at least a portion of the data, and/or otherwise rendering the data useless.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

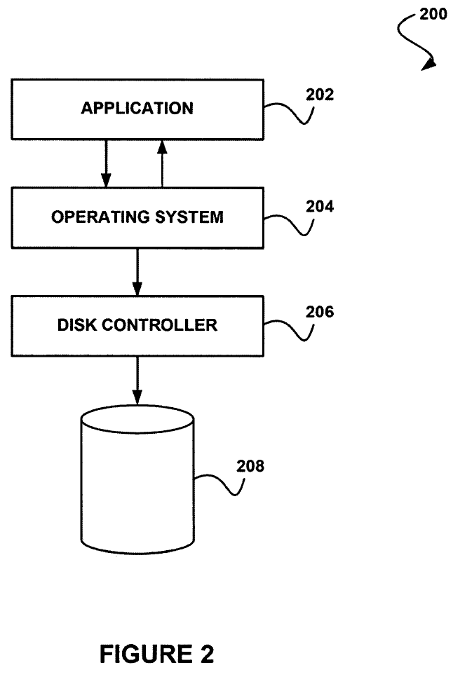

FIG. 2 shows a system 200 for rendering at least a portion of data useless in immediate response to a delete command, in accordance with one embodiment. As an option, the present system 200 may be implemented to carry out the method of FIG. 1. Of course, however, the system 200 may be implemented in any desired environment. Again, the aforementioned definitions may apply during the present description.

As shown, the system 200 includes a software application 202. Additionally, an operating system 204 is provided, the operating system capable of interfacing with the software application 202. In this case, the software application 202 may include any application such as an application included with the operating system 204 or an application separate from the operating system 204.

As shown further, the operating system 204 is in communication with a memory controller 206 (e.g. a disk controller, etc.). Furthermore, the memory controller 206 is capable of controlling memory 208. In this case, the memory 208 may include any device capable of storage.

For example, in various embodiments, the memory 208 may include a mechanical storage device and/or a non-mechanical storage device (e.g. semiconductor-based, etc.). Such non-mechanical storage device may, for example, include volatile or non-volatile memory. In one embodiment, the nonvolatile storage device may include flash memory.

For example, the nonvolatile storage device may include a single-bit per cell NOR flash memory, a multi-bit per cell NOR flash memory, a single-bit per cell NAND flash memory, a multi-bit per cell NAND flash memory, a multi-level-multi-bit per cell NAND flash, a large block flash memory, FeNAND, a resistive memory, or a phase change memory, etc. Furthermore, in various embodiments, the memory may be included in a portable memory device or a memory device included as part of a system. For example, the memory may include a portable flash memory device, an external hard drive, and any other portable memory device. Furthermore, the memory 208 may be memory included in a device such as a desktop computer, lap-top computer, a personal digital assistant (PDA) device, a mobile phone device, or any other device capable of including memory.

In operation, the application 202 communicates with the operating system 204, requesting that the operating system 204 delete at least a portion of data stored in the memory 206. In this case, the data may include a file, a folder, and/or any other data. In one embodiment, the data may include data associated with the application 202 (e.g. a file generated by the application 202, etc.).

The operating system 204 may then attempt to write zero data for the portion of the data by sending a request to the memory controller 206. The memory controller 206 may receive the request via an interface and, instead of automatically writing all zero data for the portion of the data, the memory controller 206 may initiate a process for rendering at least a portion of the data useless. The process may then be carried out utilizing the memory controller 206, a processor associated with the system 200, and/or utilizing any other hardware device or software.

Thus, the process for rendering at least a portion of the data useless may be initiated utilizing a command. For example, the command may include a write command instructing a system to write a string of zeros. In another embodiment, the command may include a modified write command. In these cases, the commands may be sent by the application 202 or from the operating system 204.

In one embodiment, the process may be initiated in immediate response to a delete command to reduce a chance that the data is accessible for security purposes. For example, instead of marking the data instructed to be deleted by the application 202 such that the data is still accessible, the process may render the data useless to reduce the chance that the data is accessible.

In another embodiment, the process may avoid immediate deletion of all of the data for performance purposes. For example, the process may not immediately delete all of the data if it is determined that deleting the data immediately would be an inefficient use of system resources. In this case, the process may wait until it is determined that deleting the data would not affect, or minimally affect, system performance. This determination may be based on current system resource usage, for example.

In one embodiment, the operating system 204 may indicate that the data is not available, in immediate response to the delete command. For example, the application 202 may issue a command to delete the data. The operating system may receive this command and subsequently indicate that the data is not available, if it is determined that the data is not available.

In any case, the sending of a delete command by the application 202 (e.g. a command to delete a file, etc.) may instantaneously indicate that the data to be deleted was deleted, at an application level. The operating system 204 may then issue a command to write all zeros to the data space corresponding to the data to be deleted, and the process for rendering at least a portion of the data useless may be initiated.

As noted above, the process for rendering the data useless may be implemented such that system performance is not adversely affected and such that the data is not vulnerable to security breaches. Furthermore, the process may be implemented utilizing various techniques to accomplish this.

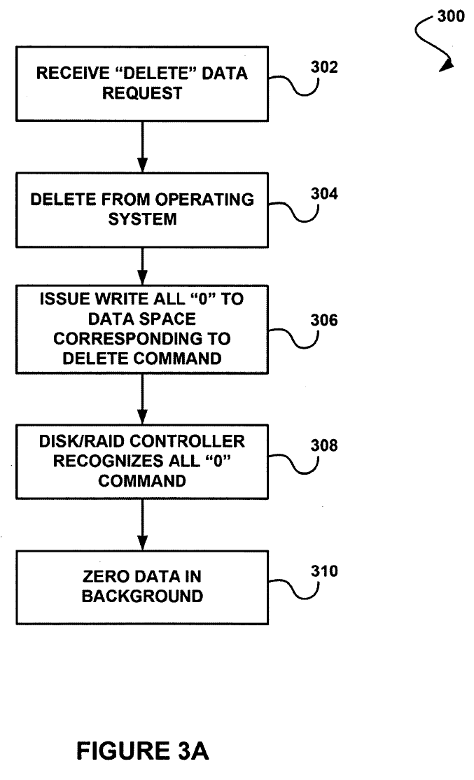

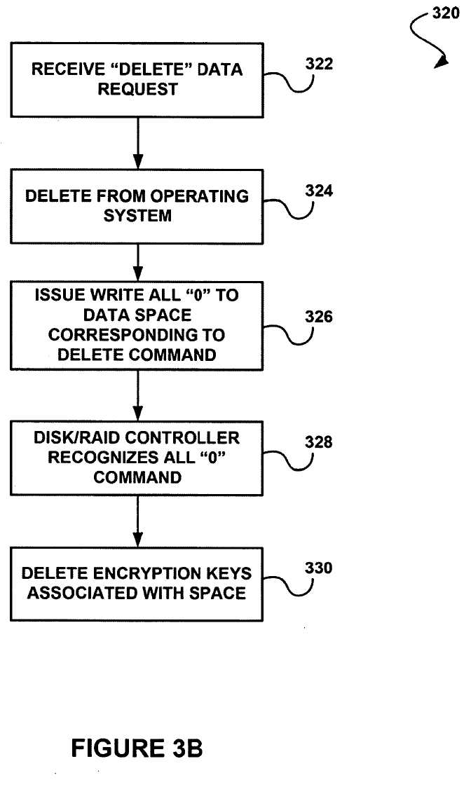

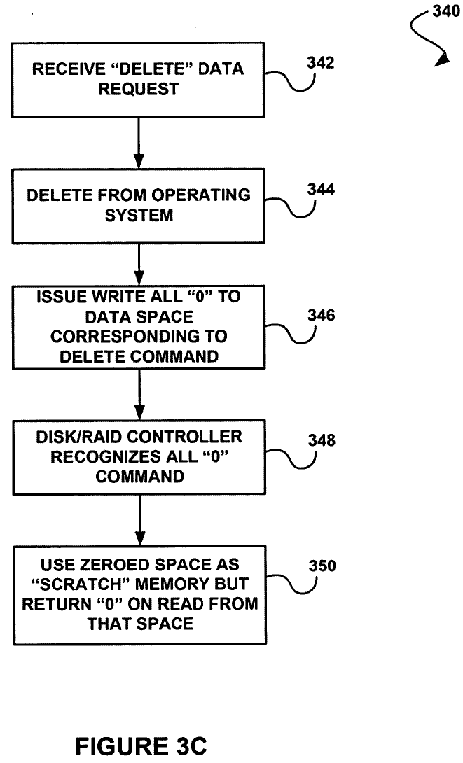

FIG. 3A shows a method 300 for rendering at least a portion of data useless in immediate response to a delete command, in accordance with another embodiment. As an option, the present method 300 may be implemented in the context of the functionality and architecture of FIGS. 1-2. Of course, however, the method 300 may be carried out in any desired environment. Again, the aforementioned definitions may apply during the present description.

As shown, a request to delete at least a portion of data stored in memory is received. See operation 302. The delete request is then acknowledged and an operating system issues a delete command. See operation 304.

As part of the delete command, the operating system issues a command to write all zeros to the data space corresponding to the delete command. See operation 306. This command is received and recognized by a memory controller, such as a disk controller or a redundant array of independent disks (RAID) controller. See operation 308.

Subsequently, a process for rendering at least a portion of the data useless is invoked. The process may be invoked utilizing the memory controller (e.g. using firmware associated with the memory controller, etc.), software, or another device capable of invoking the process. In this case, the process for rendering at least a portion of the data useless includes zeroing at least a portion of the data in the background. See operation 310.

In this way, the data may be zeroed without causing a loss of performance in the system performing the zeroing, as the zeroing is accomplished as a background process. As another option, a pattern may be written to the data space including the data to be zeroed. For example, a write instruction may include a logical block address, a section number, and a pattern to be written to the data space. This pattern may also be written in a background process.

FIG. 3B shows a method 320 for rendering at least a portion of data useless in immediate response to a delete command, in accordance with another embodiment. As an option, the present method 320 may be implemented in the context of the functionality and architecture of FIGS. 1-3A. Of course, however, the method 320 may be carried out in any desired environment. Further, the aforementioned definitions may apply during the present description.

As shown, a request to delete at least a portion of data stored in memory is received. See operation 322. The delete request is then acknowledged and an operating system issues a delete command. See operation 324.

As part of the delete command, the operating system issues a command to write all zeros to the data space corresponding to the delete command. See operation 326. This command is received and recognized by a memory controller, such as a disk controller or a RAID controller. See operation 328.

Subsequently, a process for rendering at least a portion of the data useless is invoked. As noted above, the process may be invoked utilizing the memory controller (e.g. using firmware associated with the memory controller, etc.), software, or another device capable of invoking the process. In this case, the process for rendering at least a portion of the data useless includes deleting the encryption keys associated with an address space corresponding to the data. See operation 330.

The encryption keys may include any keys or other data used to decrypt the data stored in memory. In this way, if the data space is protected by encryption keys, the deletion of the encryption keys will render encrypted data associated with the keys useless. In this case, the process may be initiated in immediate response to the delete command to reduce a chance that the data is accessible for security purposes. Furthermore, by deleting the encryption keys, minimal system resources are used, thus conserving an overall performance of the system.

FIG. 3C shows a method 340 for rendering at least a portion of data useless in immediate response to a delete command, in accordance with another embodiment. As an option, the present method 340 may be implemented in the context of the functionality and architecture of FIGS. 1-3B. Of course, however, the method 340 may be carried out in any desired environment. Once again, the aforementioned definitions may apply during the present description.

As shown, a request to delete at least a portion of data stored in memory is received. See operation 342. The delete request is then acknowledged and an operating system issues a delete command. See operation 344.

As part of the delete command, the operating system issues a command to write all zeros to the data space corresponding to the delete command. See operation 346. This command is received and recognized by a memory controller, such as a disk controller or a RAID controller. See operation 348.

Subsequently, a process for rendering at least a portion of the data useless is invoked. Again, the process may be invoked utilizing the memory controller, software, or another device capable of invoking the process. In this case, the process for rendering at least a portion of the data useless includes using the space to be zeroed as scratch memory and returning “0s” on reads from that space. See operation 350.

In the content of the present description, scratch memory refers to memory that may be utilized to store temporary data or data used for intermediate computations. Of course, in some embodiments, such scratch memory may be utilized to store non-temporary data. In either case, that portion of memory may be used for storing additional data.

Upon an instruction to read the initial data from such data space, zeros may be returned. In this way, the process may result in an appearance that the at least the portion of the data is zeroed. Furthermore, the data space may be utilized without causing a loss of performance in a system.

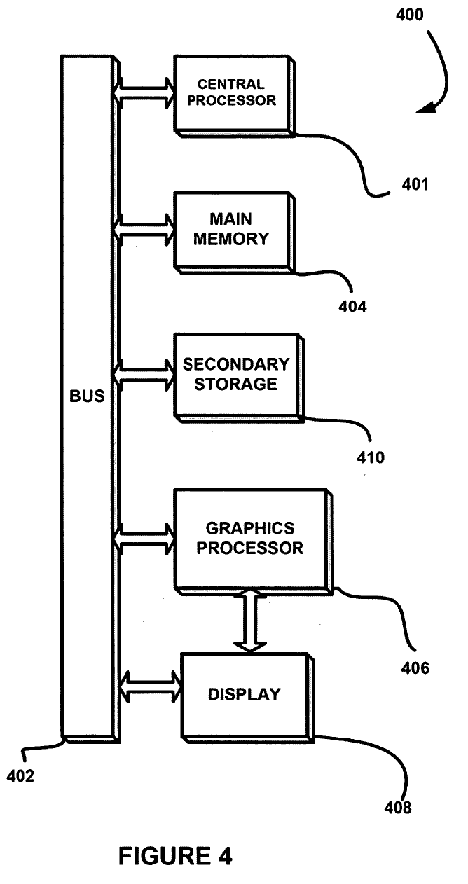

FIG. 4 illustrates an exemplary system 400 in which the various architecture and/or functionality of the various previous embodiments may be implemented. As shown, a system 400 is provided including at least one host processor 401 which is connected to a communication bus 402. The system 400 also includes a main memory 404. Control logic (software) and data are stored in the main memory 404 which may take the form of random access memory (RAM).

The system 400 also includes a graphics processor 406 and a display 408, i.e. a computer monitor. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 404 and/or the secondary storage 410. Such computer programs, when executed, enable the system 400 to perform various functions. Memory 404, storage 410 and/or any other storage are possible examples of computer-readable media.

In one embodiment, the architecture and/or functionality of the various previous figures may be implemented in the context of the host processor 401, graphics processor 406, an integrated circuit (not shown) that is capable of at least a portion of the capabilities of both the host processor 401 and the graphics processor 406, a chipset (i.e. a group of integrated circuits designed to work and sold as a unit for performing related functions, etc.), and/or any other integrated circuit for that matter. In yet in another embodiment, the architecture and/or functionality of the various previous figures may be implemented in the context of the secondary storage 410.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, lap-top computer, and/or any other type of logic. Still yet, the system 400 may take the form of various other devices including, but not limited to, a personal digital assistant (PDA) device, a mobile phone device, a television, etc.

Further, while not shown, the system 400 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
receiving a delete command directed to an operating system for deleting data from memory; and
in immediate response to the delete command, initiating a process for rendering at least a portion of the data useless.

2. The method as set forth in claim 1, wherein the process includes a background process.

3. The method as set forth in claim 1, wherein the data is encrypted and the process deletes a key associated with the encryption.

4. The method as set forth in claim 1, wherein the process zeroes at least the portion of the data.

5. The method as set forth in claim 1, wherein the process results in an appearance that the at least the portion of the data is zeroed.

6. The method as set forth in claim 1, wherein the process results in the memory being used as scratch memory.

7. The method as set forth in claim 1, wherein the process is carried out utilizing a memory controller.

8. The method as set forth in claim 1, wherein the process is initiated utilizing a command.

9. The method as set forth in claim 8, wherein the command includes a write command instructing a system to write a string of zeros.

10. The method as set forth in claim 8, wherein the command includes a modified write command.

11. The method as set forth in claim 1, wherein the process is initiated in immediate response to the delete command to reduce a chance that the data is accessible for security purposes.

12. The method as set forth in claim 1, wherein the process avoids immediate deletion of all of the data for performance purposes.

13. The method as set forth in claim 1, wherein the operating system indicates that the data is not available, in immediate response to the delete command.

14. The method as set forth in claim 1, wherein the memory includes non-volatile memory.

15. The method as set forth in claim 1, wherein the memory is included in a portable memory device.

16. A computer program product embodied on a computer readable medium, comprising:
computer code for receiving a delete command directed to an operating system for deleting data from memory; and
computer code for, in immediate response to the delete command, initiating a process for rendering at least a portion of the data useless.

17. The computer program product as set forth in claim 16, wherein the process includes a background process.

18. The computer program product as set forth in claim 16, wherein the data is encrypted and the process deletes a key associated with the encryption.

19. The method as set forth in claim 16, wherein the process zeroes at least the portion of the data.

20. A system, comprising:
an interface for receiving a delete command directed to an operating system for deleting data from memory; and
a memory controller for, in immediate response to the delete command, initiating a process for rendering at least a portion of the data useless.
